(19) United States
(12) Patent Application Publication
(10) Pub. No.: US 2025/0004626 A1
(43) Pub. Date: Jan. 2, 2025

(54) HOST RESOURCE INTERACTION IN VIRTUAL CONFERENCE ENVIRONMENTS

(71) Applicant: International Business Machines Corporation, Armonk, NY (US)

(72) Inventors: Jin Shi, NINGBO (CN); Lu Fu, NINGBO (CN); Jing Lei Guo, NINGBO (CN); Jie Jiang, NINGBO (CN); Wen Juan Nie, NINGBO (CN); Ke Huan Yin, NINGBO (CN)

(73) Assignee: International Business Machines Corporation, Armonk, NY (US)

(21) Appl. No.: 18/216,261

(22) Filed: Jun. 29, 2023

(51) Int. Cl. G06F 3/04847; G06F 40/205; H04L 65/403

(52) U.S. Cl. CPC G06F 3/04847; G06F 40/205; H04L 65/403

(57) ABSTRACT

An embodiment parses, by a host plugin, a host content view into a plurality of host resources. The embodiment identifies, by an attendee plugin, an attendee interaction with a host resource in the plurality of host resources. The embodiment transmits, by the attendee plugin, based on the attendee interaction, a resource request for the host resource. The embodiment transmits, by the host plugin, based on the resource request, a host resource content associated with the host resource. The embodiment executes, by the attendee plugin, based on the host resource content, a response action for presenting the host resource content.

### BACKGROUND

The present invention relates generally to virtual conference environments. More particularly, the present invention relates to a method, system, and computer program for enabling host resource interaction in virtual conference environments.

Virtual conferencing is a technology-enabled method of conducting meetings or conferences wherein the participants are located in different geographical locations. It is a type of real-time communication that uses internet-based technologies to initiate a live, visual connection between individuals or groups. Virtual conferencing enables individuals to communicate synchronously, sharing audio, video, and text, as well as various forms of data and multimedia content. It provides the ability for individuals to meet, discuss, and make decisions without the need for physical presence in the same location.

### SUMMARY

The illustrative embodiments provide for host resource interaction in virtual conference environments. An embodiment includes parsing, by a host plugin, a host content view into a plurality of host resources. The embodiment also includes identifying, by an attendee plugin, an attendee interaction with a host resource in the plurality of host resources. The embodiment also includes transmitting, by the attendee plugin, based on the attendee interaction, a resource request for the host resource. The embodiment also includes transmitting, by the host plugin, based on the resource request, a host resource content associated with the host resource. The embodiment also includes executing, by the attendee plugin, based on the host resource content, a response action for presenting the host resource content. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example host resource-action-response table in accordance with an illustrative embodiment.

FIG. 4 depicts a block diagram of an example process for requesting a host resource in accordance with an illustrative embodiment.

FIG. 5 depicts a block diagram of an example process for modifying a host resource in accordance with an illustrative embodiment.

FIG. 6 depicts a graphical representation of an example host view in accordance with an illustrative embodiment.

FIG. 7 depicts a graphical representation of an example attendee view in accordance with an illustrative embodiment.

FIG. 8 depicts a block diagram of an example process for enabling host resource interaction in virtual environments in accordance with an illustrative embodiment.

### DETAILED DESCRIPTION

Teleworking, also known as remote working, involves employees performing their job duties from locations outside the traditional office environment. This shift has been increasingly adopted across a variety of industries and is typically facilitated by employees working from home or a co-working space. This new mode of working has fundamentally changed the dynamics of work and has led to the development and rapid adoption of a variety of digital tools designed to facilitate remote collaboration.

The rise of teleworking has been largely enabled by advancements in technology, particularly in the areas of internet connectivity and digital collaboration tools. High-speed internet has allowed employees to stay connected with their colleagues and superiors regardless of geographical location, maintaining the necessary flow of communication for effective teamwork. Digital tools such as email, instant messaging, project management software, and more, allow teams to manage and execute tasks with efficiency, even when team members are spread across different time zones.

Video conferencing software, a significant component of the remote working toolkit, has revolutionized the way meetings, presentations, and discussions are held in the modern workplace. Previously, these activities would have required all participants to be physically present in the same location, but video conferencing has made it possible for real-time participation regardless of location. A key feature of most modern video conferencing tools is screen sharing, which allows a participant to share their computer screen with other attendees. This facilitates demonstrations, presentations, and collaborative work on digital resources.

However, the current video conferencing technology often provides a passive viewing experience for most attendees. Attendees can view the shared screen but are limited when interacting directly with the content being shared. This situation results in a less engaging and less collaborative experience. For instance, attendees need to maintain their own set of notes and documents separately, often switching back and forth between the video conferencing window and their note-taking or document-editing applications. In addition, collaborative annotation or real-time content updates are generally not possible without the presenter manually incorporating input from the attendees. This cumbersome process can lead to miscommunication and inefficiency, thereby disrupting the smooth functioning of the collaborative process.

The present disclosure addresses the deficiencies described above by providing a process (as well as a system, method, machine-readable medium, etc.) that effectively enables host resource interaction in virtual conference environments. This novel invention enhances the interactivity and collaborative capabilities of virtual conferencing.

The illustrative embodiments provide for host content view interactions by an attendee in virtual conference environments. A “host,” as used herein, may refer to an individual or group who initiates, organizes, or controls the virtual conference. The host might be a team leader, a meeting facilitator, a teacher, or anyone else who guides the flow of the meeting or presentation. The host may hold administrative privileges in the virtual conference environment. This power can extend to sharing content, admitting or removing participants, moderating discussions, controlling participant audio and video, recording the session, and managing other interactive features. In a corporate scenario, for instance, the host could be the project manager who has organized a video meeting to discuss the latest progress and future roadmap of the project.

A “host content view,” as used herein, may refer to any digital content or tool that the host might share or utilize during the virtual conference. A host content view can take various forms; it could be text, a hyperlink, an image, a video clip, a PowerPoint presentation, a document, an application software, or a live view of a specific web page or an entire desktop. The host content view may form the core of the discussion, presentation, or collaborative activity happening in the virtual conference. For instance, during a web-based seminar (webinar), the host might share a series of slides that explain a particular concept or product.

An “attendee,” as used herein, may refer to any participant in a virtual conference other than the host. Attendees can include colleagues, clients, students, or other invitees. Attendees may have viewing rights to the host content view and can interact with it based on the permissions set by the host. For example, in a virtual academic lecture, the students participating would be the attendees who can view the host content view, such as lecture slides, ask questions, and potentially annotate or comment on the host content view.

An “interaction,” as used herein, may refer to any activity that a participant in the virtual conference performs related to the host content view. Interactions can take various forms, ranging from simple viewing of the host content view to more complex actions such as making annotations and suggesting edits. In a collaborative work session, an interaction might involve a participant adding comments or highlighting crucial points in a shared document, or perhaps sharing an additional view to complement the host's content view.

A “virtual conference environment,” as used herein, may refer to a digital platform, software, or application where the virtual conference takes place. The environment could range from a general-purpose video conferencing applications to specialized platforms designed for webinars, virtual classrooms, or large-scale virtual events. Features of a virtual conference environment may include video and audio communication, text-based chat or instant messaging, screen sharing, and additional functions for interactive collaboration like whiteboarding, polling, breakout rooms, and more.

Illustrative embodiments include a host plugin and an attendee plugin. A “host plugin.” as used herein, may refer to a specialized software component that may be integrated into or separate from the virtual conference environment. It may be designed to assist the host in managing and sharing resources during a virtual conference. The plugin can have a variety of features tailored to the needs of the host, such as organizing shared content, moderating attendee interactions, managing access permissions to host resources, and tracking participant engagement. For example, the host plugin could help the host in a virtual corporate training to efficiently manage a slide presentation, allow or deny attendees' requests to annotate the slides, and monitor the participants' interactions with the shared content.

An “attendee plugin,” as used herein, may refer to a specialized software component designed to enhance attendee interaction with the host content view in the virtual conference environment. As with the host plugin, the attendee plugin may be integrated into or separate from the virtual conference environment. It may offer functionalities such as enabling direct interaction with shared resources, providing tools for note-taking, facilitating real-time chat, and allowing more complex actions like annotating or suggesting edits to the shared content, based on the permissions set by the host. For instance, in an online classroom, the attendee plugin could allow students to highlight important points in the lecture notes shared by the teacher or ask questions directly on the shared content.

Illustrative embodiments include parsing a host content view into a plurality of host resources. A “host resource,” as used herein, may refer to a unique element or component derived from the host content view. For example, a shared document could be parsed into different host resources where each paragraph, image, video, link, chart, or table is considered a separate host resource.

Parsing a host content view into a plurality of host resources may include breaking up the host content view by content type, such as text, images, videos, links, or any other discrete component. This may include identifying and separating different types of content in the shared host resource. For instance, a shared webpage could be parsed into various host resources, such as main body text, embedded images, linked videos, and hyperlinks, each treated as a distinct host resource.

Illustrative embodiments include externalizing a host resource. Externalizing a host resource may involve making the host resource independently accessible outside the original host content view, such as via a defined interface or service. For instance, an image from a shared document could be externalized and made available as a separate file that attendees can individually access, view in detail, annotate, or download.

Illustrative embodiments include identifying an attendee interaction with a host resource. An “attendee interaction,” as used herein, may refer to activity performed by an attendee in relation to a host resource. Such interactions can range from passive actions like viewing or hovering over a host resource, to active actions like clicking, copying, annotating, or commenting on a host resource. The process of identifying these interactions may involve detecting mouse movements, clicks, keyboard inputs, and other user interface events. For instance, if an attendee in a webinar moves their cursor over a hyperlink shared in the host content view and clicks it, the attendee plugin could register this as an interaction and subsequently process it.

Illustrative embodiments include transmitting a resource request. A “resource request.” as used herein, may refer to an action initiated by an attendee to access a host resource. It might involve asking to view a specific segment of a shared video, adding a comment to a presentation slide, or suggesting an amendment in a document. In some embodiments, for instance, a resource request may take the form of a GET request containing information related to a user interaction resulting in the request, such as right-clicked text, images, or videos, and/or any other information related to the user interaction such as the coordinates of the user's mouse or host resource that the user has interacted with.

Responding to a resource request may involve acknowledging and processing the attendee's request. This step may involve identifying the host resource being requested, determining the nature of the request (whether it is to view, interact, or modify), and checking the attendee's permission level to perform the requested action. For example, a request might be to access an image from a shared document for closer examination or to suggest an amendment to a paragraph in a shared text document.

Illustrative embodiments include transmitting a host resource content associated with a host resource. A “host resource content,” as used herein, may refer to data, information, or functionality provided by a host resource. This could be the text in a paragraph, the image in a picture file, the video in a media file, the URL in a hyperlink, or the software tool in an application, among others. For example, in a product presentation, the host might share a paragraph of text with a website link for attendees to learn more about the product. The host resource content in this case may be the text and the hyperlink in the presentation, which the attendees can view, copy, or modify based on their permissions.

Transmitting a host resource content may involve sending data associated with a host resource, which may involve data transmission over the network, providing a link to download or access the host resource, or any other suitable method depending on the nature of the host resource and the capabilities of the virtual conference environment. This process may involve sending the actual data or information contained in a host resource to the attendees or making it accessible to them in some way. The transmission method might vary depending on the type and size of the host resource content. For instance, if the host resource is a text document, the host plugin could send the text content directly to the attendees via their attendee plugin. If the host resource is a large video file, the plugin might provide a streaming link or a download link instead.

Illustrative embodiments include transmitting a modification request. A “modification request.” as used herein, may refer to an amendment proposed or made by an attendee to a host resource. This could be a correction, an annotation, an addition, or any other form of alteration to the host resource. For instance, in a document review session, a host resource modification could involve an attendee suggesting a change in wording or formatting of a paragraph in a shared document.

Illustrative embodiments include presenting a modification approval request to a host for an approval of a proposed modification. A “modification approval request,” as used herein, may refer to a user interface element indicating a proposed alteration to a host resource. For example, if an attendee proposes a wording change in a shared document during a review session, a modification approval request could be triggered in the system to alert the host and seek their approval before incorporating the proposed change. This process may involve presenting a pop-up dialog box, a notification in the host's user interface, or any other user interface element. For example, if an attendee suggests bolding a particular sentence in a shared document, a modification approval request may be created by the system and presented to the host. This request might display the current state of the sentence and how it would appear if the proposed modification is implemented, providing the host with a clear understanding of the impact of the change.

Illustrative embodiments include modifying a host content view based on a proposed modification. Modifying a host content view based on a proposed modification may involve updating an element visible on a shared screen. For instance, upon approval of the aforementioned modification request (bolding a sentence), the host's view of the shared document may be instantly updated to reflect this change. This may apply to the text and any associated properties like font, color, or paragraph formatting.

In some embodiments, modifying a host content view may be based on an approval of a proposed modification. In such embodiments, the proposed change may only be reflected in the host's view if the host approves it. For instance, if a participant proposes to delete a sentence in a shared document, the sentence would only disappear from the host's view upon the host's approval of the deletion.

Illustrative embodiments include presenting a merge approval request to a host for an approval to merge a proposed modification. A “merge approval request,” as used herein, may refer to a user interface element seeking the host's permission to consolidate a proposed modification into the existing host resource. For instance, if two attendees propose different edits to the same sentence in a shared document, the system could present a merge approval request to the host. This request could display both proposed changes and ask the host how they should be merged together, if at all. This gives the host granular control over the collaborative process, ensuring that the final version of the shared content aligns with their expectations.

Illustrative embodiments include modifying the host resource based on the proposed modification. This step may involve making changes to the host resource in response to a host resource modification request. Depending on the nature of the modification and the system's capabilities, this could involve updating the host resource data, creating a new version of the host resource, or marking the host resource with annotations or change indicators, or any other modification.

In some embodiments, the modifying of a host resource may be based on a host acceptance (or decline) of the host resource modification. This feature may provide a controlled interaction by making the final modification of the host resource contingent on the host's acceptance or decline of the proposed host resource modification. Such confirmation may provide an additional layer of control to the host, ensuring that the integrity of the host resource is maintained, and unwanted changes are not inadvertently incorporated.

For example, if an attendee makes a suggestion to alter a particular data point in a shared spreadsheet, this suggestion may be first captured as a host resource modification request. This request could then trigger a process in the system where the proposed change is highlighted for the host's review. The host might receive a notification, or the suggested change might be marked visibly in their interface. The system can be designed to either pause until the host makes a decision, or it can proceed with other operations while the host's decision is pending.

The host can then choose to accept or decline the modification. If the host accepts, the system may proceed to update the host resource, applying the modification to the specific data point in the spreadsheet. Depending on the settings and preferences, this modification could also be made visible to other attendees, either immediately or after the meeting. If the host declines, the system may disregard the modification request, and the original shared host resource may remain unchanged.

The decision-making process may be executed in real-time during the meeting, or the host could review and decide on all changes at the end of the session. This flexibility may allow the host to manage the session according to their needs and the nature of the meeting. This feature may be useful in collaborative environments where multiple attendees are interacting with the host resource simultaneously, and the host needs to maintain a coherent and consistent version of the host resource.

Illustrative embodiments include transmitting a modified host resource content associated with a modified host resource. Modifying a host resource content may involve making changes or amendments to the data or information contained within the host resource. For example, if an attendee suggests a change in a formula within a shared spreadsheet, modifying the host resource content could involve altering the formula within the spreadsheet based on the suggestion, which may be contingent on the host's approval. Once a change has been approved and implemented, the updated version of the host resource may be transmitted to other attendees. For example, after a paragraph in a shared document has been revised and approved, the revised version is sent to all attendees, allowing them to view the latest version of a host resource.

Illustrative embodiments include updating, based to a modified host resource content, a presented host resource content. A presented host resource content may be a specific data or information that is currently being displayed or shared by the host with the attendees. For example, in a presentation, the slide currently being displayed to the attendees may be considered the presented host resource content. Updating the presented host resource content based on the modified host resource content may mean that the shared view seen by the attendees is also updated to reflect the latest version of the host resource. For instance, if a paragraph in a shared document is deleted and the modification is approved, the presented document viewed by all attendees may automatically update, and the deleted paragraph would no longer be visible.

Illustrative embodiments include executing a response action for presenting a host resource content. A “response action,” as used herein, may refer to an action or function executed by the system in response to an attendee's interaction with the host resource. For example, if an attendee selects a hyperlink within a shared document, a response action could be the system opening a new browser window to display the webpage associated with the hyperlink. The execution of a response action for presenting the host resource content could involve various operations depending on the nature of the shared resource and the proposed modification. For example, if a modification involves the launch of an application embedded within the shared document, the system would execute the application, and the resulting output would be presented as part of the host resource content.

In some embodiments, a response action may include a copy action, an application execution, and/or a navigation. A “copy action.” as used herein, may refer to the process of identifying, extracting, and/or duplicating specific content from a host resource for further use. The extraction could involve technologies like optical character recognition to identify text on a shared screen. For example, an attendee might right-click on a piece of identified text and select “copy.” In response to this action, the system may duplicate the selected text into the attendee's clipboard, enabling immediate utilization of the text in other applications, like note-taking software, without necessitating manual transcription.

An “application execution,” as used herein, may refer to launching an application or opening a referenced resource, depending on the nature of the object and the action performed by the attendee. For example, if an attendee interacts with a recognized video or image within the host resource, the system could respond by opening a separate window that displays the selected media content in more detail. This application execution may provide an effortless way for attendees to access additional resources linked in the presentation without exiting the conferencing environment.

A “navigation,” as used herein, may refer to guiding the attendee to a source of data associated with a host resource. This might involve redirecting the attendee to a different location separate from the virtual conferencing environment based on their interactions. For instance, if the attendee clicks a recognized hyperlink within the host resource, the system could capture the URL associated with the hyperlink and execute an action that opens the associated webpage in a new browser tab or window. This navigation action may allow attendees to explore external information more thoroughly, enabling a deeper engagement with the material presented within the virtual conference.

Illustrative embodiments include presenting a permission control panel including an attendee permission for a host resource. A “permission control panel,” as used herein, may refer to an interface that may allow the host to set and manage the permissions and access levels of attendees with respect to the host resource. In some embodiments, for example, an attendee permission may include a read-only permission, an interactable permission, and/or a writable permission. Other attendee permission may be used, however. For instance, “read-only” permission may allow an attendee to only view the host resource, while “interactable” permission may let an attendee interact with the host resource (like triggering an application to view a video or image), and “writable” permission may grant the attendee the power to propose modifications to the host resource. The host may assign these permissions based on the nature of the meeting and the roles of the attendees, giving them a high level of control over the collaborative process.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for host resource management is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

While it is understood that the process software for host resource management may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

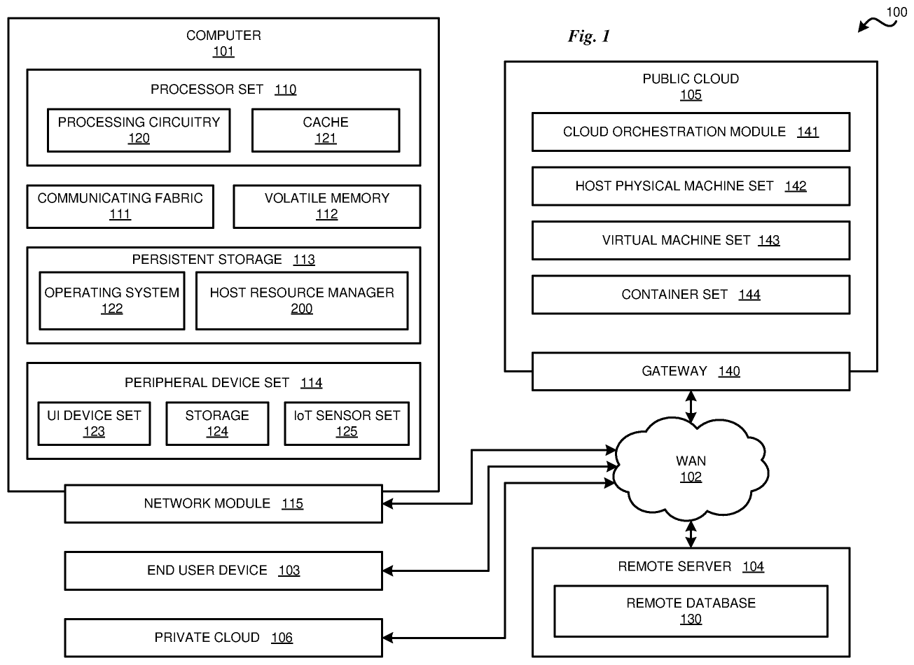

With reference to FIG. 1, this figure depicts a block diagram of a computing environment 100. Computing environment 100 contains an example of an environment for the execution of at least some of the computer code involved in performing the inventive methods, such as host resource manager 200 for managing host resource interactions. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

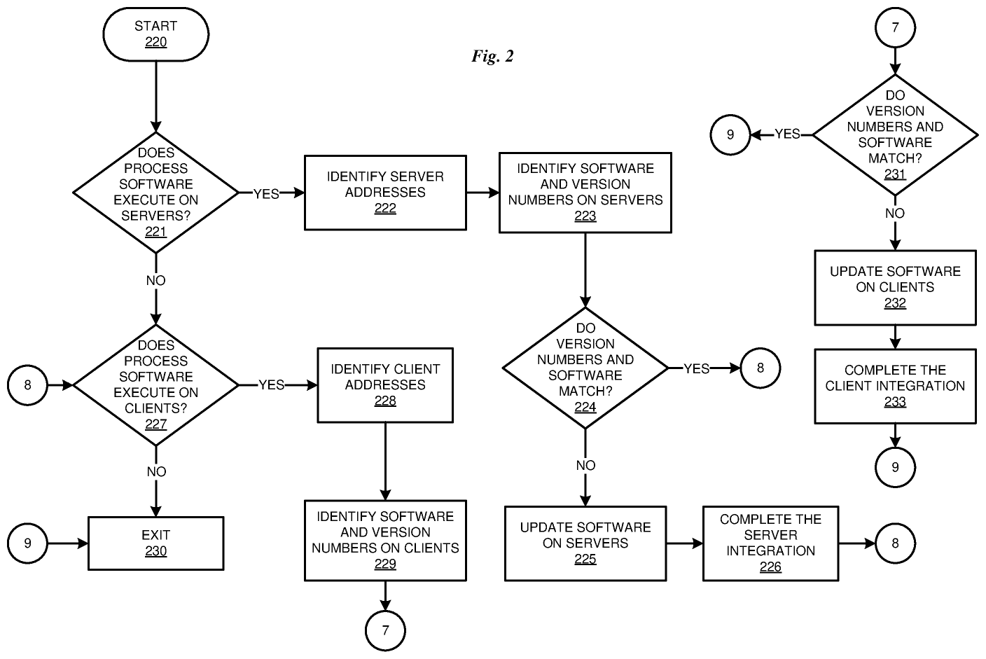

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

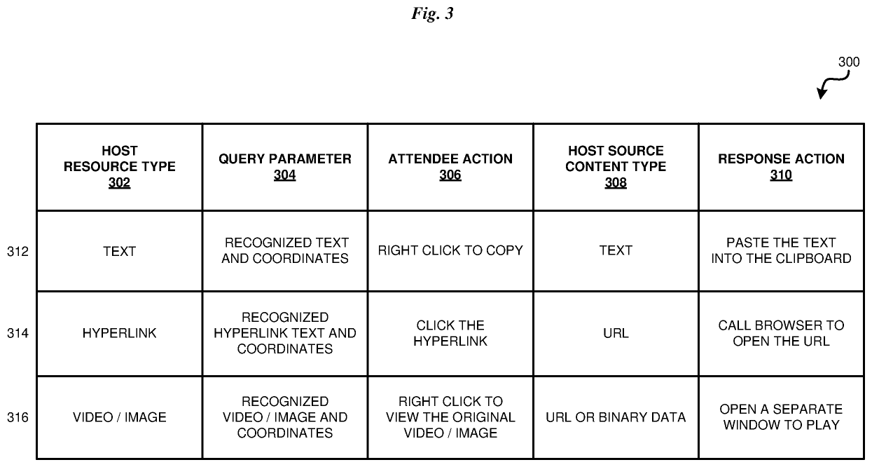

With reference to FIG. 3, this figure depicts an example host resource-action-response table 300. It is to be understood that other host resources, actions, and/or responses may be implemented depending on the particular application, as would be appreciated by those having ordinary skill in the art upon reviewing the present disclosure.

In the depicted example, host resource type column 302 may represent the different types of host resources that can be parsed from a host content view, such as host resources found in a host's shared screen. These host resource types could include various forms of content like text, images, videos, hyperlinks, and other elements. Each row in the table may correspond to one host resource type. For example, one row might represent text-based host resources while another could correspond to hyperlinks found within the host content view.

Query parameter column 304 may represent any data associated with a host resource and the user interaction that is supported with a host resource. For example, if the user interacts with a host resource of the host content view, the query parameter may be recognized text, links, images, videos, or any other element. Further, the query parameter may include the coordinates of the host resource that the attendee interacted with, which the system may use to identify the specific host resource in the host content view. Any other desired information may be included in the query parameter depending on the specific use, however, as would be appreciated by those having ordinary skill in the art upon reviewing the present disclosure.

Attendee action column 306 may represent the actions that an attendee might perform on a host resource. The actions can be context-specific and dependent on the nature of the host resource. Actions might include right-clicking to copy text, clicking a hyperlink, or right-clicking to view the original video or image, among others.

Host resource content type column 308 may represent the form in which the parsed host resource is stored or transmitted. This could vary based on the type of host resource and the requirements of the system. For example, text might be stored as plain text, a hyperlink as a URL, and videos or images as binary data or as a URL if they are hosted online.

Response action column 310 may represent a response to an attendee's action. This can vary based on the action and the nature of the host resource. For instance, if an attendee chooses to copy text, the response might be to paste the text into the attendee's clipboard. If a hyperlink is clicked, the response could be to open the URL in a browser. If an attendee chooses to view a video or image, the system might open it in a separate window.

Turning to the contents of the table, row 312 may represent an action and a response associated with a host resource type of “text.” In this scenario, the system may employ text recognition to identify and extract text from the host's shared screen, which may then be sent as part of the query parameter along with its coordinates in the shared screen. For example, the system may employ optical character recognition or any other technology capable of distinguishing textual elements within complex and mixed media presentations. The attendee action column may capture possible user interactions with the parsed text. For instance, an attendee might right-click on a particular piece of text and select “copy” to capture it. The corresponding host resource content type may be the plain text that was recognized and extracted. The system may then respond to this user action by pasting the selected text into the attendee's clipboard. This process may facilitate immediate use of this text in another context or application, like note-taking software, without having to manually transcribe it.

Row 314 may represent an action and a response associated with a host resource type of “hyperlink.” Just as with text, the system may employ text recognition to identify and extract the link's text, which may then be transmitted as part of the query parameter alongside its coordinates. Hyperlinks are common components of presentations or shared documents, providing additional resources or references. When an attendee action is initiated, such as clicking the recognized hyperlink, the system may capture the URL associated with the hyperlink, which is the host resource content type. In response to this interaction, the system might trigger a new browser tab or window to open the associated webpage. This process may enable attendees to easily access additional content or resources that are relevant to the presentation without leaving the virtual conferencing environment.

Row 316 may represent an action and a response associated with a host resource type of “video” or “image.” In these cases, the system might use image recognition techniques to identify the video or image, which may then be transmitted as part of the query parameter to along with its coordinates. Given the visual nature of these resources, attendee actions might include right-clicking to view the original video or image in more detail. The host resource content type may be the URL or binary data associated with the selected video or image. As a response action, the system could open a separate window to display the video or image. This process may allow attendees to engage with the media content more fully, perhaps watching a video from the start or examining an image in greater detail, enhancing the overall interaction within the virtual conference.

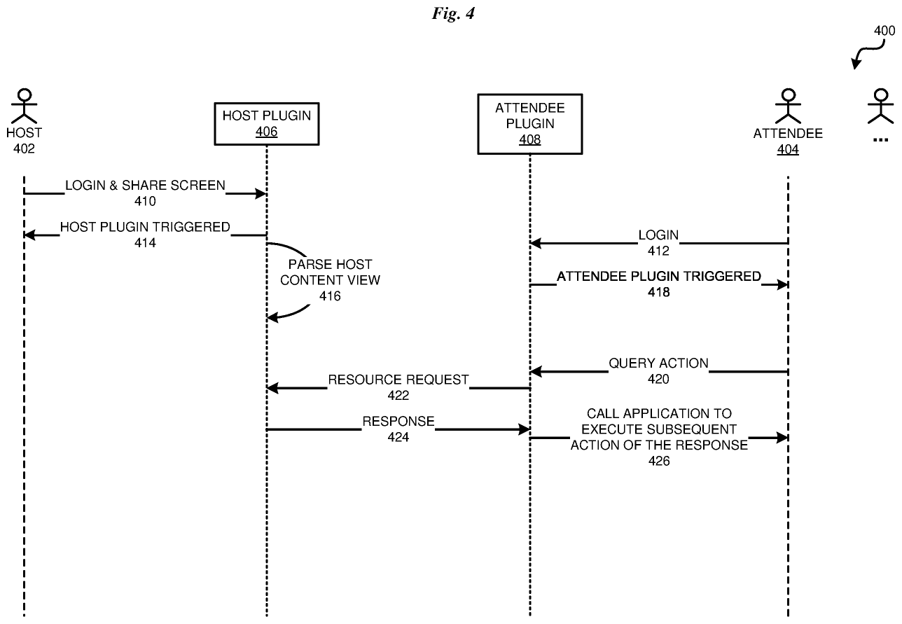

With reference to FIG. 4, this figure depicts a block diagram of an example process for requesting a host resource 400, which various illustrative embodiments may implement. As shown in the illustrative example, the process may involve a host 402, one or more attendees 404, a host plugin 406, and an attendee plugin 408.

Host 402 may represent an individual or entity that initiates the virtual conference and controls the host resources. The host might be a presenter in a webinar, a teacher in an online classroom, or a team leader in a remote business meeting. Their role may include presenting information and providing host resources through their screen which may include text, images, videos, hyperlinks, and other types of content.

Attendee(s) 404 may represent one or more participants in the virtual conference who interact with the host and the host resources. They could be students in a digital classroom, participants in a webinar, or team members in a remote meeting. Their role may include consuming the information presented by the host, asking questions, participating in discussions, and interacting with the host resources.

Host plugin 406 may represent software that facilitates the sharing of host resources by the host in the virtual conference environment. The host plugin may be integrated into the virtual conferencing application, or it may be a separate application such as a web browser plugin in a web-based virtual conferencing platform. This plugin may be configured to parse the host content view into individual host resources, transform host resources into interactive elements that can be accessed (e.g., as REST services), receive resource and modifications requests, transmitting responses to the attendee plugin or another component, and any other suitable function as described herein.

Attendee plugin 408 may represent a complementary software component that enables the attendees to interact with the host resources in real time. This could include identifying user actions (which could involve actions such as clicking, copying, or viewing elements on a shared screen), transmitting requests to access or modify a host resource, receiving responses from the host plugin or another component, initiating response actions (which could involve opening a browser or calling another application), or any other suitable function as described herein.

At block 410, host 402 may log into host plugin 406 thereby initializing the virtual conferencing process. The application here may refer to a specific software module integrated into the conferencing platform that handles host resource sharing. For instance, in a video conferencing meeting, the host may log into the video conferencing application, enabling them to start the meeting and share their screen with the attendees.

At block 412, attendee(s) 404 may log into attendee plugin 408, which may be a specialized software module designed to facilitate interactive participation in the conference as noted previously. This plugin might offer various functionalities such as direct interaction with the shared screen, note-taking, real-time chat, etc. It may be akin to an attendee joining the video conferencing meeting and gaining access to the host's shared screen and the features provided by the video conferencing application to interact with the host and other attendees.

At block 414, the host plugin may be triggered. The host plugin could be software capable of parsing the host's shared screen and transforming its contents into interactive host resources. For instance, when the host starts sharing a PowerPoint presentation, the plugin might parse the text, images, and links on each slide, making these elements accessible as REST services.

At block 416, the process may parse a host content view. This step may involve parsing the host content view into manageable, interactive components based on their content types such as text, images, videos, links, etc. The host plugin may use techniques such as optical character recognition for text, image recognition algorithms for images, and hyperlink extraction for links. This process may convert static screen content into interactive elements that attendees can directly interact with.

At block 418, the attendee plugin may be triggered. Once activated, the attendee plugin may facilitate real-time interaction between the attendee and the host resources. It might allow attendees to click or hover over parsed elements and execute actions like copying text, opening links, or viewing images in more detail.

At block 420, the attendee may generate a query action. For example, an attendee could move their cursor over a parsed link on the shared screen and right-click to open the link. The plugin may register this as a query action, which it further processes.

At block 422, the attendee plugin may transmit a resource request to the host plugin. This step may involve generating a corresponding query parameter and sending a request, such as a GET request, to the host plugin. The query parameter could contain details about the requested host resource and the action the attendee intends to perform. For instance, the query parameter could be the URL and coordinates of the parsed hyperlink that the attendee wishes to open. It then prepares a response, which could involve fetching the required data or preparing the host resource for the requested action. For example, if the attendee has requested to open a link, the host plugin might fetch the URL and coordinates from the parsed host resource to include it in the response.

At block 424, the host plugin may transmit a response to the attendee plugin. This transmission could be, for instance, a JavaScript Object Notation (JSON) object containing the requested data, like the URL of a hyperlink, and/or commands for subsequent actions like opening a browser window.

At block 426, the attendee plugin may call an application to execute a subsequent action of the response. For instance, upon receiving a response with a URL, the plugin might call upon the attendee's default browser to open a new tab with the given URL.

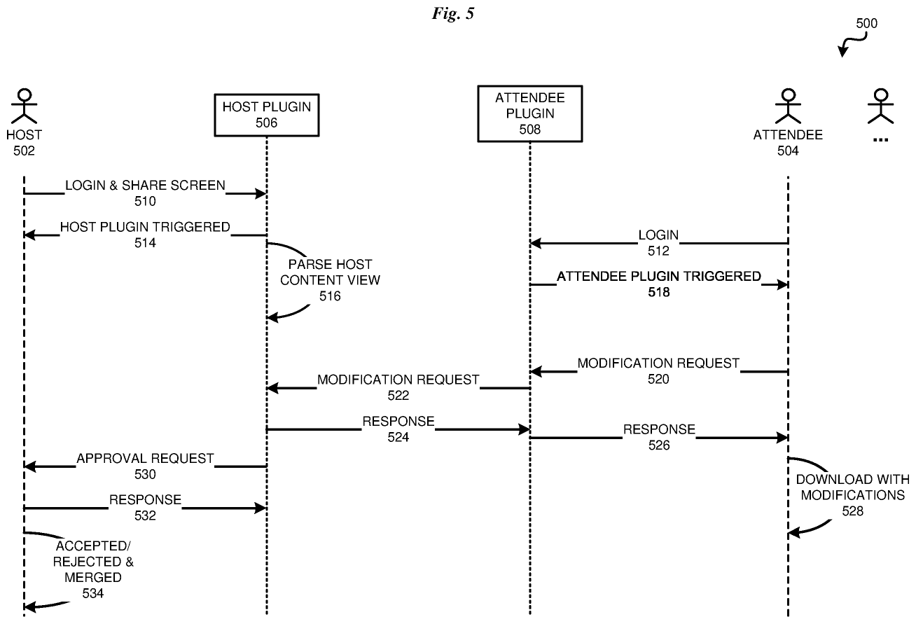

With reference to FIG. 5, this figure depicts a block diagram of an example process for modifying a host resource 500, which various illustrative embodiments may implement. As shown in the illustrative example, the process may involve a host 502, one or more attendees 504, a host plugin 506, and an attendee plugin 508, which may correspond to host 402, attendee(s) 404, host plugin 406, and attendee plugin 408 of FIG. 4. Further, blocks 510, 512, 514, 516, and 518 of FIG. 5 may correspond to blocks 410, 412, 414, 416, and 418 of FIG. 4.

As shown, at block 520, the attendee may provide a modification request, such as inserting text, changing colors, deleting content, or annotating a certain section. This modification request can happen in a variety of contexts. For example, during a shared Word document review, the attendee might suggest new sentences or change the formatting of a paragraph. The attendee's application would capture this modification request, which may include the details of what content was affected, what the specific change was, and where it occurred on the shared screen. The screen position may be represented using x and y coordinates or a section identifier depending on the type of content being shared.

At block 522, the attendee plugin may transmit the modification request to the host plugin. For example, it may formulate a POST request, packaging the details of the modification request into the body of the request. The format of this request may follow a standard such as JSON, Extensible Markup Language (XML), or a URL-encoded format. For instance, if an attendee adds a note to a slide in a PowerPoint presentation, the POST body could contain information like the slide number, the note's text content, and the exact position where the note was added. This POST request may be then transmitted over a Hypertext Transfer Protocol (HTTP) connection to the host plugin for processing.

At block 524, the host plugin may transmit a response to the attendee plugin. The host plugin may decode the request, extracting the proposed changes from the POST body. In response, the host plugin may then construct an acknowledgment message. This message may be sent back to the attendee plugin to confirm that the proposed changes have been received. This transmission may use a response code, such as HTTP 200 for successful receipt, with additional information about the processing status in the response body.

At block 526, the attendee plugin may transmit a response to the attendee. This step may involve transmitting the acknowledgment response. It may then update the attendee's user interface accordingly, showing a status update about the proposed change. This might be a temporary pop-up message, a status bar update, or a more permanent marker attached to the proposed change. For instance, if the attendee suggested a text change, the plugin could highlight the proposed change and display a message like “Change proposed: waiting for host approval.”

At block 528, the attendee may download the host resource with their proposed modifications incorporated. The attendee plugin may generate a copy of the host resource that includes the attendee's changes and then initiate a download. For example, if the host resource is a project plan document, the attendee's plugin could download a version of this plan with the attendee's notes and edits included, preserving their input for later reference. In some embodiments, the modifications may be subject to the host's approval.

At block 530, the host plugin may generate an approval request for each proposed change, which may be sent to the host for review. The approval request could be a user interface element like a popup or a dedicated section in the host's interface, detailing the proposed modifications, their origin, and their impact. The host can then review these changes and decide whether to accept or reject each one.

At block 532, the host may submit their decisions, transmitting them back to the host plugin. The host could make their decision using a simple user interface, such as checkboxes for accepting or rejecting changes, or dropdown menus for selecting different levels of acceptance. The host's decisions may then be communicated back to the host plugin.

At block 534, based on the host's decisions, the attendee's modifications may be integrated into the host resource, rejected, or stored separately in the meeting records. For example, if the host approves a change, it might be immediately applied to the host resource, visible to all attendees in real time. Alternatively, if the host decides to only record the change, the host plugin could store it as metadata, preserving the record of the attendee's input without altering the shared content during the meeting.

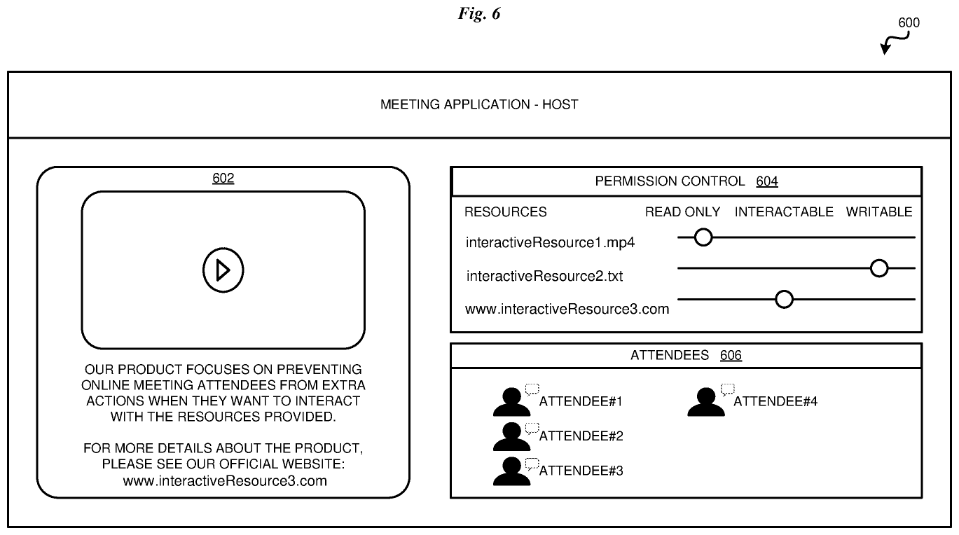

With reference to FIG. 6, this figure depicts a graphical representation of an example host view 600, in accordance with various illustrative embodiments. As shown in the illustrative example, the host view may comprise host content view 602, permission control panel 604, and attendee panel 606. This host view may present a graphical representation of a screen during an online meeting, demonstrating how a host may manage host resources and permissions for attendees. It may allow a host to control interactions with host resources shared in an online meeting, which might include documents, videos, websites, and other types of data. It is to be understood that a host view may include other components, as would be appreciated by those having ordinary skill in the art upon reviewing the present disclosure.

Host content view 602 may represent the main area of the host view, where the content of the meeting is displayed. In the example provided, it contains text that explains the purpose of the meeting: to present a product focusing on preventing unnecessary actions for attendees when they interact with the host resources during online meetings. It includes details of a product that streamlines this process, and a website link for attendees who wish to learn more about the product. The host content view may be the primary space for sharing and presenting information, and its layout and functionality may change based on the type of host resource being shared. For instance, if a video is being shared, the host content view may contain playback controls, whereas if a document is shared, the host content view might include text editing or annotating tools.

Permission control panel 604 may serve as a hub for setting and managing permissions for host resources in the meeting. In this instance, it lists three different host resources, interactiveResource1.mp4, interactiveResource2.txt, and www.interactiveResource3.com, each of which may correspond to an element present in the host content view. For instance, interactiveResource1.mp4 may represent the video in the host content view, interactiveResource2.txt may represent the text explaining the purpose of the meeting, and www.interactiveResource3.com may represent the hyperlink located at the bottom of the host content view. Next to each host resource, there may be permission settings divided into three categories: read-only, interactable, and writable. The host can control whether attendees can merely view the host resources (read-only), interact with the host resources in a limited way (interactable), or propose modification to the host resources (writable). For example, the host might decide that a text document should be writable so attendees can collaboratively edit it, but a video file should be interactable, meaning attendees can play or pause the video, but cannot edit the video content itself.

Attendee panel 606 may provide a list of all attendees in the meeting. In this illustration, it displays four attendees labelled Attendee #1 through Attendee #4. The host can use this panel to view who is currently in the meeting. The attendee panel might also display additional attendee-specific information or controls, such as status indicators, direct messaging options, or the ability to mute or remove attendees.

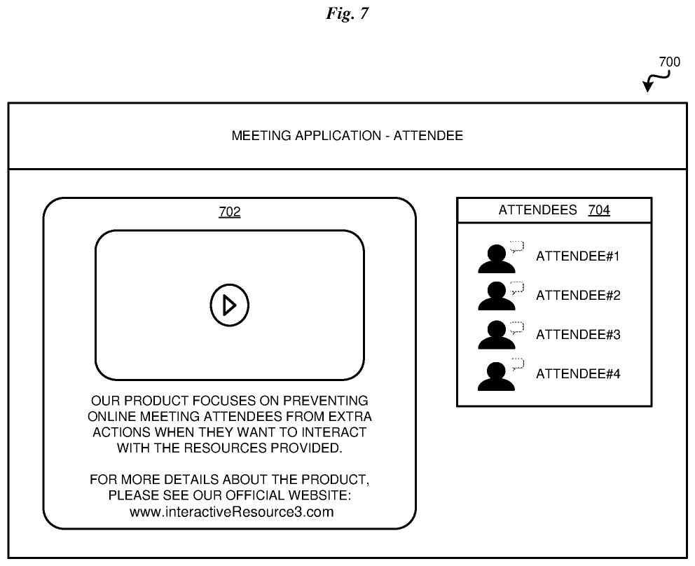

With reference to FIG. 7, this figure depicts a graphical representation of an example attendee view 700, in accordance with various illustrative embodiments. As shown in the illustrative example, the attendee view may comprise host content view 702 and attendee panel 704. This attendee view may allow an attendee to interact with host resources shared in an online meeting, which might include documents, videos, websites, and other types of data. It is to be understood that an attendee view may include other components, as would be appreciated by those having ordinary skill in the art upon reviewing the present disclosure.

Host content view 702 may be the main visual area where the host content view and meeting information are displayed from the perspective of an attendee. Similar to the host view, it features an explanatory text about a product aimed at reducing unnecessary actions for attendees during an online meeting. It also presents a link to a website where further details about the product can be found. The actual content displayed in this area would be dependent on what the host has decided to share, and can range from presentations, video files, spreadsheets, to website URLs. However, unlike the host view, the attendee view from an attendee's perspective does not allow permission controls and can allow interactions based on the settings provided by the host. For example, a host might have shared a text document and set it as “interactable,” which would enable the attendee to select and copy text, but not modify it.

Attendee panel 704 may provide a roster of all participants in the online meeting, allowing the attendee to see who else is present in the meeting. In this given instance, it shows four attendees labeled from Attendee #1 through to Attendee #4. It is important to note that in the attendee view, the controls and options available in the panel could be limited compared to those in the host view. For instance, while the host may have the ability to mute or remove attendees, an attendee may not have the same level of control. In some cases, the attendee panel may provide options for attendees to communicate with the host or other attendees, such as chat or direct messaging functions.

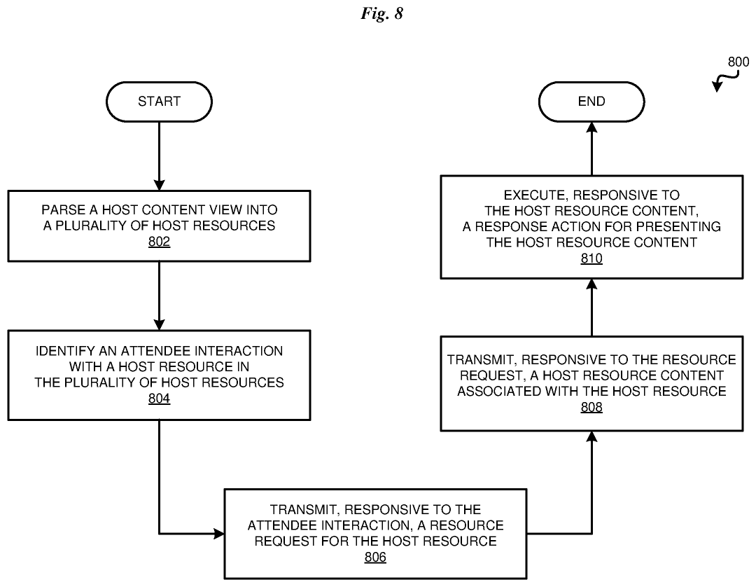

With reference to FIG. 8, this figure depicts a block diagram of an example process for enabling host resource interaction in virtual environments 800. The example block diagram of FIG. 8 may be implemented using host resource manager 200 of FIG. 1.

In the illustrative embodiment, at block 802 the process may parse a host content view into a plurality of host resources. Parsing may involve segmenting or breaking down the host content view into identifiable parts or resources. This could be various elements within a shared document, different application windows if the host is sharing their entire screen, or different sections of a webpage. For example, if the host is presenting a PowerPoint slide, parsing could involve identifying individual text boxes, images, charts, and other elements on the slide as separate host resources.

At block 804 the process may identify an attendee interaction with a host resource in the plurality of host resources. This process may involve tracking the activities of attendees within the shared screen view and determining when an attendee engages with a particular host resource. For instance, an attendee could click on a hyperlink in a shared document, highlight a section of text, or hover over an image, and these actions would be recognized by the system as interactions with those respective host resources.

At block 806 the process may transmit, responsive to the attendee interaction, a resource request for the host resource. A resource request may seek further details or actions regarding the specific resource. If an attendee hovers over an image in a shared webpage, for example, a resource request could be generated asking for a higher resolution version of the image or the URL where the image is hosted.

At block 808 the process may transmit, responsive to the resource request, a host resource content associated with the host resource. The host resource content may refer to the specific data or information within the resource that was subject to the attendee's interaction. If the resource request was for a higher resolution version of an image, for instance, the system would send the requested image as the host resource content.

At block 810 the process may execute, responsive to the host resource content, a response action for presenting the host resource content. A response action may be an activity or function carried out by the system to facilitate the attendee's interaction with the host resource. If the host resource content was a higher resolution image, a response action could involve opening the image in a separate viewing window for the attendee.

It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising.” “includes,” “including.” “has.” “having.” “contains” or “containing.” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially.” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
parsing, by a host plugin, a host content view into a plurality of host resources;
identifying, by an attendee plugin, an attendee interaction with a host resource in the plurality of host resources;
transmitting, by the attendee plugin, based on the attendee interaction, a resource request for the host resource;
transmitting, by the host plugin, based on the resource request, a host resource content associated with the host resource; and
executing, by the attendee plugin, based on the host resource content, a response action for presenting the host resource content.

2. The method of claim 1, wherein the response action includes at least one of a copy action, an application execution, and a navigation.

3. The method of claim 1, further comprising:
transmitting, by the attendee plugin, responsive to a proposed modification of the host resource by an attendee, a modification request;
presenting, by the host plugin, responsive to the modification request, a modification approval request to a host for an approval of the proposed modification; and
modifying, by the host plugin, based on the approval, the host content view based on the proposed modification.

4. The method of claim 3, further comprising:
updating, by the host plugin, based on the approval, the host resource based on the proposed modification.

5. The method of claim 1, further comprising:
transmitting, by the attendee plugin, responsive to a proposed modification of the host resource by an attendee, a modification request;
presenting, by the host plugin, responsive to the modification request, a merge approval request to a host for an approval to merge the proposed modification; and
modifying, by the host plugin, based to the approval, the host resource based on the proposed modification.

6. The method of claim 5, further comprising:
transmitting, by the host plugin, a modified host resource content associated the modified host resource; and
updating, by the attendee plugin, based to the modified host resource content, the presented host resource content.

7. The method of claim 1, further comprising:
presenting, by the host plugin, a permission control panel including an attendee permission for the host resource.

8. The method of claim 7, wherein the attendee permission includes at least one of a read-only permission, an interactable permission, and a writable permission.

9. The method of claim 1, wherein the host resource includes at least one of a text, a hyperlink, an image, and a video.

10. A computer program product comprising one or more computer readable storage media, and program instructions collectively stored on the one or more computer readable storage media, the program instructions executable by a processor to cause the processor to perform operations comprising:
parsing, by a host plugin, a host content view into a plurality of host resources;
identifying, by an attendee plugin, an attendee interaction with a host resource in the plurality of host resources;
transmitting, by the attendee plugin, based on the attendee interaction, a resource request for the host resource;
transmitting, by the host plugin, based on the resource request, a host resource content associated with the host resource; and
executing, by the attendee plugin, based on the host resource content, a response action for presenting the host resource content.

11. The computer program product of claim 10, wherein the response action includes at least one of a copy action, an application execution, and a navigation.

12. The computer program product of claim 10, further comprising:
transmitting, by the attendee plugin, responsive to a proposed modification of the host resource by an attendee, a modification request
presenting, by the host plugin, responsive to the modification request, a modification approval request to a host for an approval of the proposed modification; and
modifying, by the host plugin, based on the approval, the host content view based on the proposed modification.

13. The computer program product of claim 10, further comprising:
transmitting, by the attendee plugin, responsive to a proposed modification of the host resource by an attendee, a modification request
presenting, by the host plugin, responsive to the modification request, a merge approval request to a host for an approval to merge the proposed modification; and
modifying, by the host plugin, based to the approval, the host resource based on the proposed modification.

14. The computer program product of claim 13, further comprising:
transmitting, by the host plugin, a modified host resource content associated the modified host resource; and
updating, by the attendee plugin, based to the modified host resource content, the presented host resource content.

15. The computer program product of claim 10, further comprising:
presenting, by the host plugin, a permission control panel including an attendee permission for the host resource.

16. A computer system comprising a processor and one or more computer readable storage media, and program instructions collectively stored on the one or more computer readable storage media, the program instructions executable by the processor to cause the processor to perform operations comprising:
parsing, by a host plugin, a host content view into a plurality of host resources;
identifying, by an attendee plugin, an attendee interaction with a host resource in the plurality of host resources;
transmitting, by the attendee plugin, based on the attendee interaction, a resource request for the host resource;
transmitting, by the host plugin, based on the resource request, a host resource content associated with the host resource; and
executing, by the attendee plugin, based on the host resource content, a response action for presenting the host resource content.

17. The computer system of claim 16, wherein the response action includes at least one of a copy action, an application execution, and a navigation.

18. The computer system of claim 16, further comprising:
transmitting, by the attendee plugin, responsive to a proposed modification of the host resource by an attendee, a modification request
presenting, by the host plugin, responsive to the modification request, a modification approval request to a host for an approval of the proposed modification; and
modifying, by the host plugin, based on the approval, the host content view based on the proposed modification.

19. The computer system of claim 16, further comprising:
transmitting, by the attendee plugin, responsive to a proposed modification of the host resource by an attendee, a modification request
presenting, by the host plugin, responsive to the modification request, a merge approval request to a host for an approval to merge the proposed modification; and
modifying, by the host plugin, based to the approval, the host resource based on the proposed modification.

20. The computer system of claim 16, further comprising:
presenting, by the host plugin, a permission control panel including an attendee permission for the host resource.
